(19) United States
(12) Patent Application Publication
(10) Pub. No.: US 2007/0055948 A1
(43) Pub. Date: Mar. 8, 2007

(54) Method and apparatus for processing electronic data

(75) Inventor: Zhan Cui, Colchester (GB)

Correspondence Address: NIXON & VANDERHYE, PC, 901 NORTH GLEBE ROAD, 11TH FLOOR, ARLINGTON, VA, 22203, US

(73) Assignee: BRITISH TELECOMMUNICATIONS PUBLIC LIMITED COMPANY, London (GB)

(21) Appl. No.: 10/573,153

(22) PCT Filed: Sep. 22, 2004
(86) PCT No.: PCT/GB04/04040

§ 371 Date: Mar. 23, 2006

(30) Foreign Application Priority Data
Sep. 26, 2003 (GB) 0322653.7
Sep. 26, 2003 (GB) 0322654.5

(51) Int. Cl. G06F 17/00

(52) U.S. Cl. 715/863; 707/104.1; 345/619

(57) ABSTRACT

tool providing a graphical user interface with underlying intelligence to assist a user in creating mappings between ontologies or between ontologies and database schema. For each individual mapping which a user makes the tool checks that the proposed mapping is consistent with all other proposed mappings made by the user thus far and alerts the user if an inconsistency is detected.

### FIELD OF THE INVENTION

The present invention relates to a method and apparatus for processing electronic data, and in particular, to a method and apparatus for assisting a user to map different descriptions of stored electronic data, or ontologies or data schema, to one another to render considerably easier the process of enabling computers to process stored electronic data stored on different heterogeneous databases according to correspondingly different methodologies.

### BACKGROUND OF THE INVENTION

There is acknowledged to be a general problem of data overload and information poverty. This arises because electronic data from different sources are stored on different computing systems, in different formats and described using different vocabularies. This makes it very difficult for computers in particular to process electronic data frog these different sources in a way which enables the data from one source to be compared with the data from another source; when this can be done, the data from such sources are said to be integrated. Worst of all, many context data are not explicitly stored at all, let alone in a machine comprehensible form. Differences between the ways in which data are stored on different databases is referred to as heterogeneity, and differences between various vocabularies are often referred to as semantic heterogeneity because different terms from different vocabularies may have the same meaning and the same terms used on different databases may have different meanings.

Many solutions have been proposed for addressing the above problems. However, in general, all such methods ultimately require a large amount of human effort to provide machine readable translations from one semantic representation to another so that a machine can ultimately compare like with like when processing electronic data from semantically and syntactically heterogeneous sources. Given the enormous amount of electronic data stored in semantically and syntactically heterogeneous sources, progress in enabling data from these sources to be integrated is very slow.

One particularly promising method of integrating data from semantically and syntactically heterogeneous sources is to use “ontologies”. A popular definition of ontology is that it is an explicit formal specification of a conceptualisation. Formal here means some logical formalism. A conceptualisation includes: concepts, which may denote real or abstract entities such as Person, Animal, Dog, Mood and Condition; structures, such as “Person has attributes such as name, sex, data of birth and eye-colour”; and relationships, such as “Person is a sub category of Animal”, “Person has Dog as pets”, and “Person has Mood”. Attributes and relationships add structures to concepts, hence they can be said to specify some meanings of these concepts. Furthermore, an ontology normally includes axioms which further constrain the interpretation of concepts. Example axioms are: “Person and Dog are disjoint”; “Mood cannot apply to Condition”, and so on. The specification of an ontology for a domain depends on the point of view of the author of the ontology. A domain could be modelled differently for different purposes. As models always simplify the reality, there are often different ontologies for even the same domains.

Ontologies assist in integrating data from semantically and structurally heterogeneous databases by precisely defining what differently used terminologies in the different databases actually mean. For example, one database might refer to “model ID” and a second database might refer to the same category as “product”. An ontology mapping may then be used to map “model ID” in the first ontology to “product” in the second ontology thus enabling a search request formulated in the first ontology to also retrieve relevant data from the second database by translating the search request from the first ontology to the second, etc.

As mentioned above, each concept in an ontology tends to have a number of attributes associated therewith. When mapping a concept in an ontology to a corresponding concept in a database schema, to assist with the integration of the contents of the database with the contents of another database using a different database schema, it is necessary to ensure that all of the attributes of both concepts are correctly mapped to one another or otherwise accounted for. This is a process which it is very common for human operators to perform incorrectly as it requires a large number of already specified relationships to be kept in mind and to properly understand the consequences of such relationships. These are two things which humans generally have difficulty in performing faultlessly.

Note that since the ultimate aim of integrating databases is to enable data representing real physical entities to be more efficiently processed, a tool for assisting in the integration of databases should properly be regarded as a technical tool, performing a technical function.

### SUMMARY OF THE INVENTION

According to a first aspect of the present invention, there is provided a method of generating a computer readable data file representative of a mapping between a first and a second representation of a set of concepts and associated attributes, the method comprising the steps of:
controlling a video display unit to display said first and second representations, or portions thereof, to a user;
detecting input by the user of a signal specifying a value of one or more concepts or attributes or specifying a link between two or more concepts or attributes from the first and second representations;
calculating the logical implications of such specified values or links;
controlling the visual display unit to display to the user indications of the calculated logical implications of the specified values and links; and
upon the signals of sufficient such specified values or links being detected to generate a valid mapping between said first and second representations, generating a computer readable data file representative of said valid mapping.

In the above passage, the term “representation” is intended as a general term to encompass both ontologies and database schema as well as any other explicit formal specifications of a conceptualisation.

The term “representation” is often used in the field of Ontologies, however, to refer to the syntax used in an ontology or database schema rather than the semantic meanings of the terms used in the ontology. To be clear therefore, the term syntax-representation will be used to express the concept normally understood by the term representation alone in the ontology field. Thus two different ontologies could none-the-less have the same “syntax-representation”. The above set out method is appropriate for mapping, say, two different ontologies to one another even if they have the same “syntax-representation”. More-over, the method is in fact applicable for use in “mapping” two identical ontologies to one another (ie having the same “syntax-representation” and the same semantics) although this would obviously be a fairly trivial exercise.

According to a second aspect of the present invention, there is provided apparatus for generating a computer readable data file representative of a mapping between a first and a second distinct representation of a set of concepts and associated attributes, the apparatus comprising:
controlling means for controlling a video display unit to display said first and second, representations, or portions thereof to a user;
detecting means for detecting input by the user of a signal specifying a value of one or more concepts or attributes or specifying a link between two or more concepts or attributes from the first and second representations;
calculating means for calculating the logical implications of such specified values or links;
controlling means for controlling the visual display unit to display to the user indications of the calculated logical implications of the specified values and links; and
data generation and storage means for, upon the signals of sufficient such specified values or links being detected to generate a workable mapping between said first and second representations, generating and storing a computer readable data file representative of said workable mapping.

Preferred features of the present invention are set out in the appended dependent claims.

### BRIEF DESCRIPTION OF THE FIGURES

In order that the present invention may be better understood, embodiments thereof will now be described, by way of example only, with reference to the accompanying drawings in which:

FIG. 1 is an illustration of a general purpose computer system which may form the operating environment of embodiments of the present invention;

FIG. 2 is a system block diagram of the general purpose computer system of FIG. 1;

FIG. 3 is a schematic block diagram of the network to which the general purpose computer system of FIG. 1 is attached, illustrating a full ontology based system for integrating data from multiple heterogeneous data sources;

FIG. 4 is a schematic representation of a portion of a typical ontology; and

FIG. 5 is an illustration of a graphical user interface according to an embodiment of the present invention.

### DETAILED DESCRIPTION OF A FIRST EMBODIMENT

A first embodiment of the present invention, which acts to enable a user to easily generate mappings between two ontologies, two data schema or between an ontology and a data schema, will now be described.

Description of the User Terminal

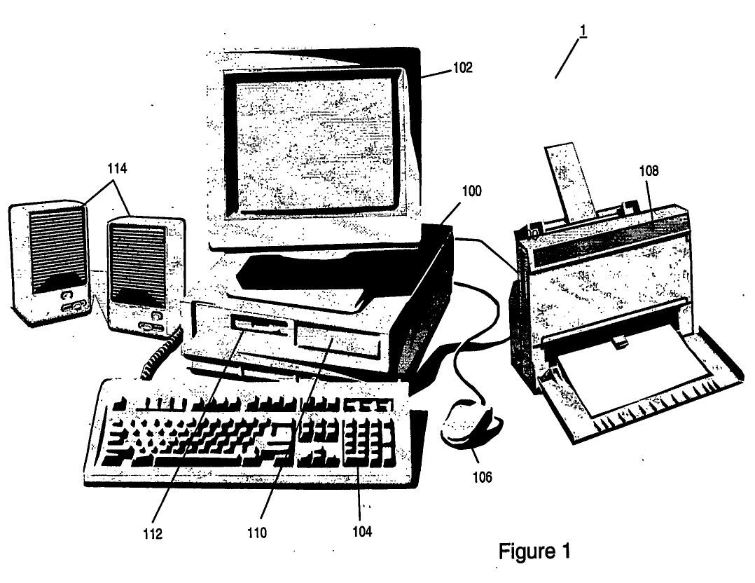

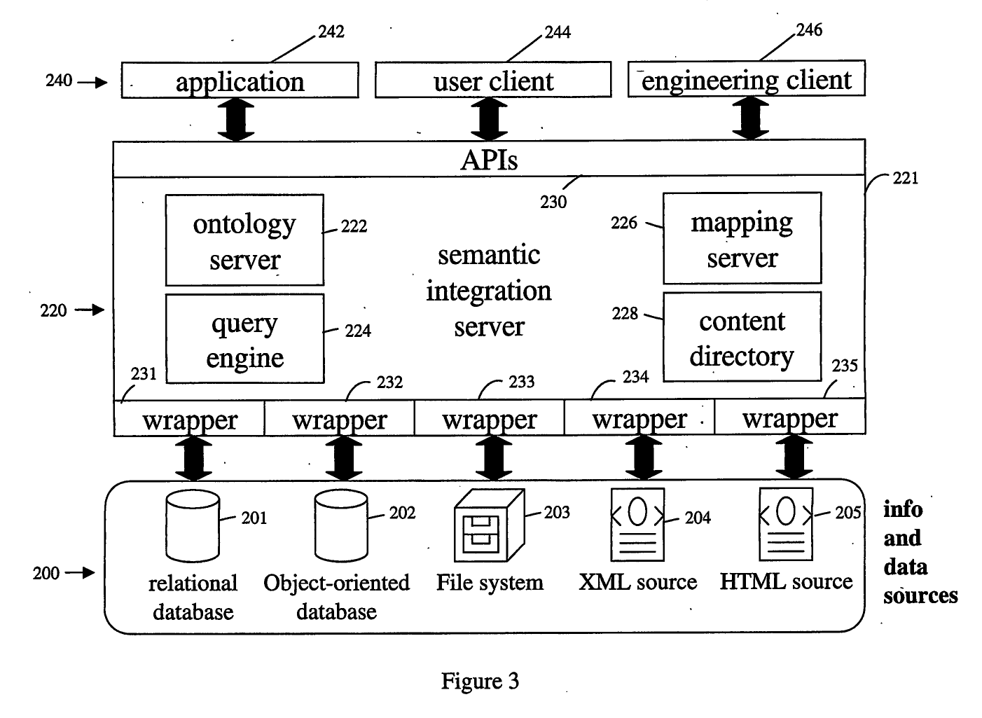

In the first embodiment, an application program is implemented on a general purpose computer system such as that illustrated in FIG. 1 and described in greater detail below. A large part of the data used by the application program of the first embodiment, together with other computer programs operating to process (or pre-process) that data is stored on other computer devices, especially computer servers and databases connected to the general computer system of FIG. 1 via a computer network as is explained in greater detail below. As with the general computer system of FIG. 1, such devices are well known in the art and are in essence very similar to the computer system illustrated in FIG. 1 with different emphases (eg a computer server is unlikely to contain a graphics card or a sound card but is likely to contain multiple Central Processor Unit (CPU) processors, etc.). FIG. 3 is a schematic illustration of the principal components of the network employed in the present embodiment.

FIG. 1 illustrates a general purpose computer system which provides the operating environment of the embodiments of the present invention. Later, the operation of the invention will be described in the general context of computer executable instructions, such as program modules, being executed by a computer. Such program modules may include processes, programs, objects, components, data structures, data variables, or the like that perform tasks or implement particular abstract data types. Moreover, it should be understood by the intended reader that the invention may be embodied within other computer systems other than those shown in FIG. 1, and in particular hand held devices, notebook computers, main frame computers, mini computers, multi processor systems, distributed systems, etc. Within a distributed computing environment, multiple computer systems may be connected to a communications network and individual program modules of the invention may be distributed amongst the computer systems.

With specific reference to FIG. 1, a general purpose computer system 1 which forms the operating environment of the embodiments of the invention, and which is generally known in the art, comprises a desk-top chassis base unit 100 within which is contained the computer power unit, mother board, hard disk drive or drives, system memory, graphics and sound cards, as well as various input and output interfaces. Furthermore, the chassis also provides a housing for an optical disk drive 110 which is capable of reading from and/or writing to a removable optical disk such as a CD, CDR, CDRW, DVD, or the like. Furthermore, the chassis unit 100 also houses a magnetic floppy disk drive 112 capable of accepting and reading from and/or writing to magnetic floppy disks. The base chassis unit 100 also has provided on the back thereof numerous input and output ports for peripherals such as a monitor 102 used to provide a visual display to the user, a printer 108 which may be used to provide paper copies of computer output, and speakers 114 for producing an audio output. A user may input data and commands to the computer system via a keyboard 104, or a pointing device such as the mouse 106.

It will be appreciated that FIG. 1 illustrates an exemplary embodiment only, and that other configurations of computer systems are possible which can be used with the present invention. In particular, the base chassis unit 100 may be in a tower configuration, or alternatively the computer system 1 may be portable in that it is embodied in a lap-top or note-book configuration. Other configurations such as personal digital assistants or even mobile phones may also be possible.

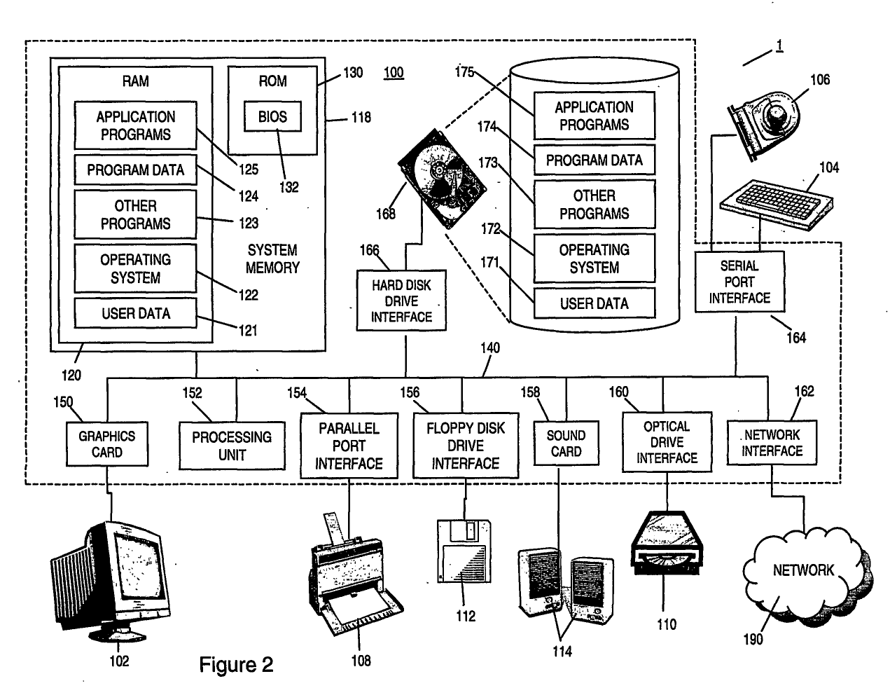

FIG. 2 illustrates a system block diagram of the system components of the computer system 1. Those system components located within the dotted lines are those which would normally be found within the chassis unit 100.

With reference to FIG. 2, the internal components of the computer system 1 include a mother board upon which is mounted system memory 118 which itself comprises random access memory 120, and read only memory 130. In addition, a system bus 140 is provided which couples various system components including the system memory 118 with a processing unit 152. Also coupled to the system bus 140 are a graphics card 150 for providing a video output to the monitor 102; a parallel port interface 154 which provides an input and output interface to the system and in this embodiment provides a control output to the printer 108; and a floppy disk drive interface 156 which controls the floppy disk drive 112 so as to read data from any floppy disk inserted therein, or to write data thereto. In addition, also coupled to the system bus 140 are a sound card 158 which provides an audio output signal to the speakers 114; an optical drive interface 160 which controls the optical disk drive 110 so as to read data from and write data to a removable optical disk inserted therein; and a serial port interface 164, which, similar to the parallel port interface 154, provides an input and output interface to and from the system. In this case, the serial port interface provides an input port for the keyboard 104, and the pointing device 106, which may be a track ball, mouse, or the like.

Additionally coupled to the system bus 140 is a network interface 162 in the form of a network card or the like arranged to allow the computer system 1 to communicate with other computer systems over a network 190. The network 190 may be a local area network, wide area network, local wireless network, or the like. In particular, IEEE 802.11 wireless LAN networks may be of particular use to allow for mobility of the computer system. The network interface 162 allows the computer system 1 to form logical connections over the network 190 with other computer systems such as servers, routers, or peer-level computers, for the exchange of programs or data.

In addition, there is also provided a hard disk drive interface 166 which is coupled to the system bus 140, and which controls the reading from and writing to of data or programs from or to a hard disk drive 168. All of the hard disk drive 168, optical disks used with the optical drive 110, or floppy disks used with the floppy disk 112 provide non-volatile storage of computer readable instructions, data structures, program modules, and other data for the computer system 1. Although these three specific types of computer readable storage media have been described here, it will be understood by the intended reader that other types of computer readable media which can store data may be used, and in particular magnetic cassettes, flash memory cards, tape storage drives, digital versatile disks, or the like.

Each of the computer readable storage media such as the hard disk drive 168, or any floppy disks or optical disks, may store a variety of programs, program modules, or data. In particular, the hard disk drive 168 in the embodiment particularly stores a number of application programs 175, application program data 174, other programs required by the computer system 1 or the user 173, a computer system operating system 172 such as Microsoft® Windows®, Linux™, Unix™, or the like, as well as user data in the form of files, data structures, or other data 171. The hard disk drive 168 provides non volatile storage of the aforementioned programs and data such that the programs and data can be permanently stored without power.

In order for the computer system 1 to make use of the application programs or data stored on the hard disk drive 168, or other computer readable storage media, the system memory 118 provides the random access memory 120, which provides memory storage for the application programs, program data, other programs, operating systems, and user data, when required by the computer system 1. When these programs and data are loaded in the random access memory 120, a specific portion of the memory 125 will hold the application programs, another portion 124 may hold the program data, a third portion 123 the other programs, a fourth portion 122 the operating system, and a fifth portion 121 may hold the user data. It will be understood by the intended reader that the various programs and data may be moved in and out of the random access memory 120 by the computer system as required. More particularly, where a program or data is not being used by the computer system, then it is likely that it will not be stored in the random access memory 120, but instead will be returned to non-volatile storage on the hard disk 168.

The system memory 118 also provides read only memory 130, which provides memory storage for the basic input and output system (BIOS) containing the basic information and commands to transfer information between the system elements within the computer system 1. The BIOS is essential at system start-up, in order to provide basic information as to how the various system elements communicate with each other and allow for the system to boot-up.

Whilst FIG. 2 illustrates one embodiment of the invention, it will be understood by the skilled man that other peripheral devices may be attached to the computer system, such as, for example, microphones, joysticks, game pads, scanners, digital cameras, or the like. In addition, with respect to the network interface 162, we have previously described how this is preferably a wireless LAN network card, although equally it should also be understood that the computer system 1 may be provided with a modem attached to either of the serial port interface 164 or the parallel port interface 154, and which is arranged to form logical connections from the computer system 1 to other computers via the public switched telephone network (PSTN).

Where the computer system 1 is used in a network environment, as in the present embodiment, it should further be understood that the application programs, other programs, and other data which may be stored locally in the computer system may also be stored, either alternatively or additionally, on remote computers, and accessed by the computer system 1 by logical connections formed over the network 190.

Description of the Networked System

Referring now to FIG. 3, the computer system 1 is connected to a number of further components, over the network 190, which are relevant to the present embodiment and these can be categorised into three different layers, namely a data source layer 200, an integration layer 220 and an application layer 240.

The data source layer includes, in the present embodiment, a relational database 201, an object-oriented database 202, a file system 203, an extended Mark-up Language (XML) source 204 and a Hyper Text Mark-up Language (HTML) source 205. Each of these provides a basic source of data and together they form a set of heterogeneous sources each of which has its own peculiar way of storing and representing data which are both syntactically and semantically distinct from one another.

The integration layer 220 comprises a plurality of “servers” which can offer “services” to other computer programs. In the present invention, all of these different services are located on a single server machine, hereinafter referred to as the integration server 221. However, in other embodiments the different services or even different parts of the same service could be distributed across a plurality of separate machines. Included in the integration layer is an ontology server 222, a query engine 224, a mapping server 226, a content directory 228, a set of Application Program Interfaces (APIs) 230 and a set of wrappers 231-235. The integration layer 220 acts to integrate the data from the heterogeneous data sources at the data source layer to enable applications at the application layer 240 to access the underlying data in an integrated manner. The operation of the components of the integration layer are described in detail in co-pending International patent application Nos. PCT/GB02/01231 and PCT/GB02/004417, the contents of which are hereby incorporated by reference into the present application.

As is explained in greater detail in the above mentioned references, the ontology server 222 stores different ontologies. In the present invention these are expressed using the Ontology Inference Layer (OIL) encoded either in XML or in accordance with the Resource Description Framework (RDF).

The query engine 224, again as is explained in greater detail in the above mentioned references, receives global queries from an application and generates sub-queries to send to one or more of the data sources 201-205, receives the result(s), integrates the result(s) if necessary and returns the integrated result back to the originating application.

The mapping server, again as is explained in greater detail in the above mentioned references, stores data files representative of mappings from one ontology to another, or from an ontology to a data schema. The nature of these maps is described in greater detail below.

The content directory, again as is explained in greater detail in the above mentioned references, stores details of which data sources 201-205 are currently on-line and a summary of what each data source which is on-line stores (or, more precisely, has available for look up by the integration layer).

The wrappers 231-235, again as is explained in greater detail in the above mentioned references, act as intermediaries between each corresponding data source 201-205 and the integration layer. Each wrapper is responsible for translating requests issued to the corresponding resource, using the common format applied at the integration layer for querying resources, into native (data source specific) requests appropriate for the corresponding data source (eg into a standard SQL request for the relational database source 201) and translating the received answers back into a format suitable for use by the query engine. Additionally, each wrapper is responsible for monitoring whether or not its corresponding data source is on- or off-line and advising the content directory accordingly as well as for providing the content directory of a summary of the data available from its respective data source while it is on-line. See the above referred to documents for details on how this may be achieved.

The API's 230 provide a well defined interface to the various components of the Integration layer, especially the query engine 224, which enables applications in the application layer to know precisely how to interact with the components at the integration layer, especially the query engine 224.

The application layer 240 includes a number of different application programs, and associated equipment on which those applications are running. A first illustrated example of a component of the application layer is a general application 242. This might, for example, be an application running on a remote terminal which enables a user to submit a general search request to the integration layer 220, which processes the request and returns the results obtained from searching over all of the appropriate data sources included in the data source layer.

The second illustrated example of a component of the application layer is a user client 244. This corresponds to the computer system illustrated in FIGS. 1 and 2 and runs an application which permits mappings to be made between different ontologies and data schema stored in the ontology server 222. The functionality of user client 244 is described in greater detail below.

The third example of a component of the application layer 240 is an engineering client. As with components 242 and 244, this typically comprises a combination of hardware and software in the form of a suitably programmed client device. The engineering client has sufficient privileges to amend not only data stored in the integration layer (as does the user client 244) but also to amend and update the functionality of the various servers within the integration layer 220. An engineering client is typically used by a system administrator who is responsible for maintaining and upgrading the network as a whole.

Discussion of Ontologies

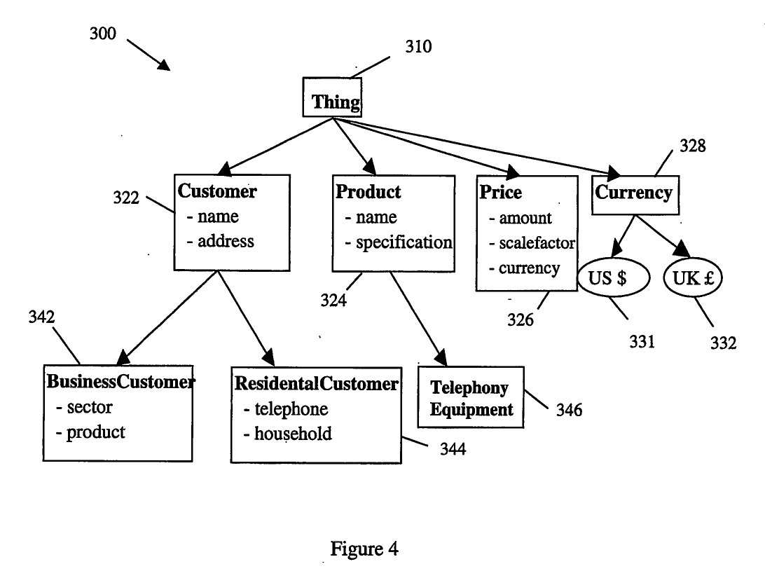

FIG. 4 is a schematic representation of a portion of a typical ontology. As shown in FIG. 4, an ontology 300 can be represented as a plurality of concepts 310-346, each concept being represented by a square box in FIG. 4, and individuals 331, 332 represented by ovals, the concepts and individuals being linked together by arrows which illustrate the nature of the relationship between the linked concepts (in FIG. 4, each arrow indicates that the concept or individual is a sub-category or individual example of the concept away from which the arrow points).

A popular definition of ontology which generally suffices for the purposes of the present application, is that it is an explicit formal specification of a conceptualisation. Formal here means some sort of logical formalism. A conceptualisation includes concepts which may denote real or abstract entities such as “Person”, “Animal”, “Dog”, “Mood”, “Condition”, “Thing”, “Customer” etc. A conceptualisation may also include structures such as <concept “Person” has attributes such as “name”, “gender”, “date of birth”, etc.> and relationships such as <concept “Person” is a sub-category of concept “Animal”>, <concept “Person” has concept “Mood”>, etc. An ontology may also include one or more axioms, such as <concept “Person” and concept “Dog” are disjoint>, <concept “Mood” cannot apply to concept “Condition”>, etc. The particular choice of specification for an ontology will depend upon the point of view of the author of the ontology. Even the same domain of knowledge could be modelled differently by the same author if the resulting ontologies are intended to be used in different applications, etc.

Thus, returning to FIG. 4, the illustrated part of ontology 300 shows the concept “Thing” 310 as being at the top of the ontology 300. Four sub-categories of the concept “Thing” are shown, namely “Customer” 322, “Product” 324, “Price” 326 and “Currency” 328, all of which are also concepts. The concept “Customer” 322 is illustrated as having two attributes (in practice it is likely to have many more) namely “-name” and “-address”. The concept “Product” 324 is illustrated as having attributes “-name” and a “-specification”. The concept “Price” 326 is illustrated as having three attributes, namely “-amount”, “-scalefactor” and “-currency”. The concept “Currency” has no attributes, but it does have two individuals, “US $” 331 and “UK ξ” 332. An individual is a more concrete thing than a concept and represents an actual example of an individual which falls within its parent concept. For example, both US $ and UK ξ are examples of actual currencies. Note also that an attribute of one concept can also be a (different) concept in its own right (for example currency as an attribute of the concept “Price” is also a concept in its own right).

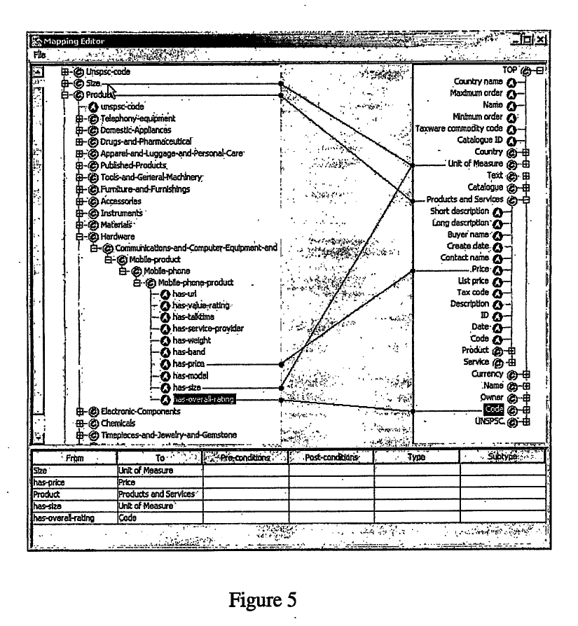

The concept “Customer” 322 has two subcategories illustrated, namely the concepts “BusinessCustomer” 342 having attributes “-sector” and “-product”. The concept “Product” is illustrated as having the concept “Telephony Equipment” 346 as a sub-category. Although not illustrated in FIG. 4, the concept “Product” actually has a large number of further sub-categories as is clear from FIG. 5.

The Tool of the Present Embodiment

Turning now to FIG. 5, this illustrates a schematic representation of the graphical user interface of the tool of the present embodiment with which a user is assisted in making mappings between two different ontologies, or between an ontology and a data schema (the present embodiment could similarly also be used to generate mappings between two different data schema although this is a less likely thing to want to do in practice). As shown in FIG. 5, the two different ontologies between which a mapping is to be made are illustrated in a pair of side-by-side oppositely facing tree structures (using, for example, a Java JTree Swing component) in the top portion of the interface, together with a table (using, for example, a Java JTable Swing component) in the bottom portion to provide details of the information stored in the mapping between the ontologies (rather than the ontologies themselves). Note that in the top portion of the interface, links between different nodes in the two facing ontologies are illustrated by way of a line (eg linking the attribute “has-price” in the left-hand-side ontology with the attribute “Price” in the right-hand-side ontology), but otherwise the information displayed is simply that of the two ontologies the details of which are stored as an OIL expression in the ontology server 222.

Upon opening up the Mapping Editor application of the present embodiment, the user is able to browse through ontologies stored in the ontology server 222 and is invited to select two such ontologies or database schemas for forming a mapping therebetween. If a mapping already exists, the user is offered the chance to create a new mapping or two amend the extant mapping. Note that mappings are stored in the mappings server 226. Assuming that the user selects to create a new mapping or selects an ontology and a data schema (or two ontologies) for which no mapping is extant, then the mapping editor will display the interface substantially in the manner of that shown in FIG. 5 but with the bottom portion initially empty.

The mapping developer then selects a term from an ontology and begins mapping to a database term. Mapping from one term to another is through a ‘click and drag’ operation. When this happens, the system tries to map attributes defined in the ontology to table attributes (or attributes defined in the other ontology if it's an ontology to ontology mapping).

The click and drag operation from one term to another is called semantic-level mapping as it does not require the mapping developers to write programs for type and syntax conversion and transformation. The system then tries the following in sequence:
1. It checks for attribute correspondences through context-based mappings in the mapping database.
2. For each found correspondence between two attributes, it retrieves type information. If the source type is different from the target type, it searches for conversion functions from the mapping database. If it succeeds in finding one, it will be used for source to target type conversion.
3. After checking for type compatibility, the tool checks for internal consistency of the tentatively found mapping, with other mappings already made; that is it performs a mapping consistency check. For example, if the user has previously assigned one of the attributes to having a constant fixed value, then it would be inconsistent to also map this to a variable attribute; or, if an attribute has already been mapped to one attribute it would be inconsistent to also map it to another attribute (unless the user can confirm that these attributes are in fact appropriately connected to one another—e.g. they are one and the same). More complex arrangements could also result in, for example, (possibly indirectly) connected attributes being mapped to concepts which are specified (by the ontology to which they belong) as being disjoint. Some examples to illustrate these possible mapping inconsistencies are given below.
4. In the present embodiment, for all attributes which are successfully matched to one another with corresponding types and where the mapping will not cause any inconsistency problems, the attributes are automatically mapped to one another (although in an alternative embodiment they might be marked as tentative mappings with user confirmation required—eg by right clicking and then selecting a “confirm” menu item—to make the mappings firm). Any other attributes are marked as requiring user attention by not connecting any mapping lines to them and colouring them, in the present embodiment, red.

When a user makes a semantic level mapping between two attributes, a similar set of steps is performed (omitting the first step). Thus it checks for type compatibility and mapping consistency and if everything is OK it automatically marks the, attributes as mapped and offers the user the option to generate a new context-based mapping rule for future use (so that such attributes would be automatically mapped together in the future when a higher level concept to table or concept to concept mapping is made without requiring the user to explicitly map the underlying attributes to one another). If the tool detects a mapping inconsistency it alerts the user to the inconsistency so that suitable corrective action may be taken (eg by changing some previously made mappings or deciding to not attempt to map together the two attributes which raised the inconsistency, etc.). If there is no inconsistency but the types are different and it has not been able to find a suitable conversion function, it prompts the user to supply a suitable conversion function which is then stored for automatic use in future cases. In both these cases where action is required by the user, a connecting line is still drawn but it is marked (by drawing it in a non-black colour) to indicate that user attention is needed.

Note that in the present embodiment a distinction is made in the marking between a mapping inconsistency and a type incompatibility with the former taking precedence over the latter. In particular, in the present embodiment, mapping inconsistencies are marked in red, type incompatibilities are marked as green. To overcome a type incompatibility a user, in theory, need only supply an appropriate conversion function (although this may be complex when say one attribute type is a concept and the other is a seemingly unrelated table etc.) whereas more drastic action might be necessary to overcome a mapping inconsistency.

Context-based mapping rules:

An ontology term is used as a context to convert data when it comes to map one message to another. This mapping is stored according to the following example:

Term A: st—street

Term A: ave—avenue

Term B: st—Saint

Term C: id=code

In checking type compatibility in an ontology, the following situations are considered:

1. All individuals or objects of a concept are considered consistent. For example, if an individual of a concept Month of an ontology A (e.g. January) is mapped to an individual of a concept month of an ontology B (e.g. JAN) then any subsequent mapping of an individual of Month to an individual of month will be deemed to be consistent.

2. Specialisation and generalisation are also considered consistent. This is checked through the assumption relationship of description logic. This is also applicable to concepts defined by logic expressions. For example, if a concept Country of an ontology A is mapped to a table Nations of a database B, and then a sub-concept EU-Country of ontology A is mapped to an attribute “origin” of a table EU-Products in database B which is linked to the table Nations, then this is considered to be consistent because EU-Country is a specialisation of Country. Examples of this type of consistency checking are given in more detail below.

3. Disjoint concepts are considered inconsistent. For example, if a concept Non-EU-Country of an ontology A is mapped to a table Nations of a database B, and then a disjoint concept EU-Country (i.e. ontology A specifies that Non-EU-Country and EU-Country are disjoint to one another) is mapped to an attribute “origin” of a table EU-Products in database B which is linked to the table Nations, then this is considered to be inconsistent because Non-EU-Country is disjoint to EU-Country.

4. In the present embodiment, all other situations are considered neutral which results in no inconsistency alerts being raised.

When a concept from an ontology is mapped to an attribute of a database table, all attributes are marked as needing attention. This is because all except one should have fixed values (indicating that the database has implicitly assumed certain fixed values for the concept's attributes without explicitly specifying them) or should be marked as unmapped (to indicate that the database just doesn't include the information pertinent to the particular attributes). For example,

A database table: Product with attributes: name: string, cost: real

An ontology concept: Price with attributes: amount: real, currency-type: string and scalefactor: integer

If Price is mapped to Product.cost, then currency-type and scalefactor would assume fixed values. These are the implicit assumptions of the cost figure in the database.

The mapping developer needs to determine what attributes should have fixed values. Again, the valid values may be presented to the mapping developer K they can be derived. Any values assigned by the mapping developer will be checked by the system.

In short the methodology prompts the mapping developer as to what information needs to be supplied. After that, mappings are checked formally. It also points out inconsistencies (if any) that the new link or value assignment may cause to the rest of the links or value assignments.

An ontology supplies a template for additional information such as the concepts “Price”, “ColourScheme”, etc. It keeps a list of what information still needs to be supplied such as currency-type and colour codes. The tool of the present embodiment also performs a full check for consistency using all of the currently available consistency checking modules installed into the tool (which may be more than were available when an indivdual mapping between two attributes was made possibly many days earlier etc.) when a mapping is committed, i.e. stored in the mapping database.

Similarly, when the mapping developer exits from the tool, all the open overall mappings are examined. If there are any overall mappings having one or more individual mappings, concepts, tables, attributes, etc. marked for attention, they are saved (ie the current state of each such overall mapping is saved) without further consistency checking. If any overall mappings have no items marked for attention, all the individual mappings (and attribute assignments, etc.) of each such overall mapping are checked again using the currently available checking modules. If no inconsistency is found, each such overall mapping is considered complete and it is committed to the mapping database, marked as valid.

The next time the developer opens the tool in the present embodiment, all non-committed overall mappings which were previously open are presented to her in the state they were left in when she previously exited the tool.

### EXAMPLES

There now follows a series of examples of differing complexity to illustrate the operation of the tool in a few instructive different circumstances.

### Example 1

Consider attempting to map the following hypothetical ontology and database to one another using the tool of the present embodiment:

Ontology 1

Country
name: string
currency: Currency

Currency
name: string
symbol: string
3-Itr code: string

Product
name: string
type: string
id: string
origin: Country
price: Price

Price
amount: number
currency: Currency
scale factor: number

Database 1 (comprises 2 tables, Nations and Products)

TABLE 1
Nations

| Name | ID | 2 ltr Code |
|---|---|---|
| Germany | 1 | DE |
| France | 2 | FR |
| UK | 3 | GB |
| Italy | 4 | IT |
| USA | 5 | US |

TABLE 2
Products

| Name | Model No. | Cost | Category | Origin ID |
|---|---|---|---|---|
| Tuffty | T111 | 19.99 | Mobile Phones | 1 |
| Skinny | T311 | 24.99 | Mobile Phones | 4 |
| — | T911 | 55.00 | Mobile Phones | 2 |
| Fast Fred | F422 | 149.00 | Fax Machines | 5 |

The Database Schema for this database is:

Nations
Name: string
ID: integer (Primary key)
2 Itr Code: string (max length 2)

Products
Name: string
Model No.: string
Cost: number
Category: string
Origin ID: integer (foreign key—Nations.ID)

When a user opens up the mapping tool of the present embodiment and selects Ontology 1 and Database 1 for mapping to one another she is presented with Ontology 1 on the left-hand-side of the display and the database schema as set out above (except with indentations inverted from left to right) on the right-hand-side of the user interface display.

The first terms which she may try to map to one another are the concept Country in Ontology 1 and the table Nations in Database 1. Upon doing this (by clicking on the one term and dragging to the other) the tool draws a line between the two concepts and then attempts to map the underlying attributes of these terms to one another automatically.

Firstly therefore it considers the attribute “name” of the concept Country. It detects the attribute “Name” of the table Nations and, because a context-based mapping rule associated with the concept Country informs it to disregard case differences, it determines that these attributes correspond to one another. It then checks the types of these attributes and determines that they are the same and therefore maps these attributes to one another automatically and therefore automatically draws a connecting line between them on the display to notify the user that these attributes have been automatically mapped to one another (note the user has the option to unmap these attributes if she decides that this automatic mapping is incorrect, however in this case the mapping is correct so the user need not take any further action in this regard).

The tool then considers the attribute currency of the concept Country. No corresponding attribute in the table Nations can, however, be found in this example so this attribute is marked as requiring attention by the user who, in this case, determines that the table Nations simply does not include this information and so she marks it as null to indicate that this attribute is to be left unmapped for the purposes of the present mapping.

Similarly, for the attributes “ID” and “2 Itr Code” of the table Nations no corresponding attributes of the concept Country in Ontology 1 can be found. These are therefore also marked as needing attention by the user who has a number of possible courses of action for resolving this inability to map in the present example. She could decide to again leave them unmapped to indicate that they are of insufficient relevance to justify finding a mapping to the Ontology 1; she could decide to form a complex context-based mapping rule to specify that the attribute “name” of the concept Country is mapped to all three attributes (or perhaps just the “Name” and “ID” attributes) of the table Nations with, for example, a comma separating the sub-strings in the attribute “name” (eg the Germany entry in table 1 would have the Name “Germany” and the ID “1” attributes both mapped to the name attribute of the concept Country to form “Germany, 1”). Finally, the user could amend Ontology 1 such that its concept Country includes two new attributes called “ID” and “2 letter code” which could then be directly mapped to the corresponding attributes in the table Nations. From hereon, it is assumed that the user takes this last course of action. At this point, the terms Country and Nations have now been successfully mapped to one another.

The user then maps the terms Product (of Ontology 1) and Products (of Database 1) to one another. As before, the tool draws a line between these two terms and then tries to map the underlying attributes to one another.

The tool determines that the attribute “name” of concept Product matches the attribute “Name” of table Products and therefore automatically maps these to one another as before (i.e. after confirming that the types of the attributes match, which they do because they are both simple strings).

The tool also determines that the attribute “type” of concept Product matches the attribute “Category” of table Products because it finds a context-based mapping rule stored in the mapping server 226 which maps “category” to “type” (these mapping rules again being case insensitive) and, since the types of these attributes are again simple strings, the tool automatically maps these attributes to one another as before.

In the present example, however, “ID” is not automatically mapped to “Model No.” because it does not find a context-based mapping rule which links these terms together. These terms are thus not mapped to any other terms and are marked as needing attention by the user. The user realises that these terms should be mapped together and therefore, by clicking and dragging one term to the other, maps these two terms together. At this point, the tool automatically checks for type correspondence. In this case the tool determines that the types of these attributes do indeed match (they are both simple strings) and therefore completes the mapping by drawing a line between the two attributes and marking the terms as not needing user attention. In the present embodiment, the tool additionally gives the user the option of generating a new context-based mapping rule specifying that in respect of the concept Product the attribute name “ID” should be mapped to “Model No.” so that in future when the user attempts to map Ontology 1 to another database, the attribute “Model No.” will be automatically mapped to “ID”.

The tool also fails to find a mapping for the attributes “origin” and “Origin ID” of the concept Product and the table Products respectively. As before therefore the user maps these to one another. The tool then checks for type correspondence and determines that the type of the attribute “origin” is the concept-Country and that the type of the attribute “Origin ID” is integer (foreign key Nations.ID). The reference to foreign key in the type declaration of the attribute “Origin ID” indicates that this attribute is linked to another table of the database, namely the Nations table. Note that this linking of tables together within a database by means of foreign keys is well understood in the art of database design; also note that the precise syntax used for performing this linking may vary from one database to another. It is clearly important that the tool understands the syntax used by the database; this function is carried out by the respective database wrapper (231-235 of FIG. 3) which presents the database schema to the tool in a standardised manner which enables the tool to correctly identify and process a foreign key type linkage. Since the Nations table has already been mapped to the concept Country the tool is able to determine that in fact the types of the attributes are the same and that the attempted mapping is consistent with the previous mappings and it therefore permits the mapping to be made. As before, the tool then gives the user the option to generate a new context-based mapping rule.

When considering the attributes “price” and “Cost” of the concept Product and table Products respectively, the tool finds a context-based mapping rule which indicates that these two terms should be linked to one another (e.g. because pluralisations as well as case are ignored). However, when the tool checks the types of these attributes it determines that their types are different (“price” is type Price whereas “Cost” is type number); it checks to see if there is a conversion available from number to Price and determines that there is not one. It therefore attempts to determine if the mapping is consistent with earlier mappings. Since neither “price” nor “Cost” has yet been mapped to anything else and since “Cost” is not linked to any other tables or attributes in Database 1, there is no inconsistency and the consistency is therefore deemed to be neutral and the attributes and connecting line are marked as gree to indicate that the user needs to specify how to convert from one to the other. In the present example, the user does this by expanding the attribute “price” to show the three sub-attributes “price.amount”, “price.currency” and “price.scalefactor” (which are determined by examining the stand alone concept Price) and then mapping the sub-attribute “price.amount” to the “Cost” attribute and assigning the sub-attribute “price.currency” to the fixed individual UK Sterling which is stored in Ontology 1 as an individual of the concept Currency with attributes UK Sterling.name=“UK Sterling”, UK Sterling.symbol=“ξ” and UK Sterling.3-Itr code=“GBP”

(Note that in general it is cumbersome to include individuals or objects in an ontology as an ontology is intended to define concepts and relationships and to define the semantics of terms used to define database tables, leaving the database tables themselves to handle actual data. However, some individuals are usefully included in an ontology. Examples include currencies, calendar months, Units of measure, etc. There are however no hard and fast rules and the flexibility of what can be stored in an ontology is a great strength of ontologies in general.)

The tool confirms that all of these individual mappings and assignments are consistent and then marks the mappings as complete. Thus when the user exits the tool the overall mapping is committed to the mapping server 226.

### Example 2

### Foreign Keys

A foreign key relation in a database is concerned with cross references between database tables. A foreign key is a field in a table which matches the primary key column of another table. To be consistent with the terminologies, in this document the name of a field or column of a database table is referred to as an attribute. If an attribute of a database table is a foreign key, it means that all of the (sub-attribute) values of the attribute must come from the values of the attribute of the (other) table to which the foreign key refers. For example,

A table Nation with attributes defined as
id: integer primary key
name: string

A table Product with attributes
origin: Integer foreign key reference Nation (id)
name: string

As mentioned above, the exact syntax may be different from database to database. Here two tables are defined: Nation and Product. The attribute “origin” of Product is declared as a foreign key referring to the “id” attribute of Nation. Because of this, any value of the “origin” attribute of Product must be valid values of the “id” attribute of Nation. That means any values not found in Nation table are not allowed to be used in “origin” of Product.

Populated tables may be like these

| Nation | id | name |
|---|---|---|
| | 1 | UK |
| | 2 | USA |

| Product | origin | name |
|---|---|---|
| | 2 | Mobile-123 |
| | 2 | Mobile-456 |
| | 1 | Fax-123 |
| | 3 | PC-123 |

The last row of Product is illegal because 3 is not present in the id column of Nation.

The corresponding ontology has concepts (also called classes) with associated attributes:

Country
id: integer
name: string

Product
origin: Country
name: string

The rows of tables are often referred to as class members, individuals or objects. Similarly ontologies can also include individuals. Thus the Country class includes individuals such as uk, usa, etc. The individual uk is declared with id as 1 and name as UK, etc.

The Product class could include p1, p2, p3, etc. with p1 declared as having origin usa and name as “Mobile-123”, etc.

It's generally very cumbersome to include objects in an ontology, since ontologies are intended to define concepts and relationships. They are normally used to define the semantics of terms used to define database tables, and leave the database to handle the data. However, some individuals are better included in an ontology. Examples include Calendar months, Units of measures, etc. There are no hard and fast rules.

### Example 3

### Examples of Checking Type Compatibility

These examples are for mappings between an ontology and database tables.

1. All individuals or objects of a concept are considered compatible.

Ontology:

EU-Product
make-in: oneOf {UK, Germany, France, Italy, Spain, etc{

Please note oneOf is a type constraint of ontology. It says the make-in value of any EU product must be one of UK, Germany, etc.

Country
name

Database:

Nation
id: integer
name: string

Product
origin: integer foreign key reference Nation (id)

Semantic mappings:

Ontology's Country to Database table Nation

EU-Product to Database table Product with the attribute make-in of EU-Product mapping to origin of table Product.

EU-Product.make-in's type is oneOf { . . . } and origin: integer of table Product is referencing to table Nation which is mapped to Country in ontology.

As all individual of oneOf of EU-Product.make-in are individuals of Country of the ontology so that these are considered to be compatible as Country is mapped to Nation.

### Example 3

### Specialisation and Generalization are Also Considered Compatible

If we add a concept called EU-Country as a sub-concept of Country of the above ontology, and declare EU-Country include UK, Germany, France, Italy, Spain, etc, we could simplify the EU-Product definition as

EU-Product
make-in: EU-Country

If we use the same mappings, we will find the type match is now:

EU-Product.make-in's type is EU-Country (instead of oneOf { . . . }) and origin: integer of table Product is referencing to table Nation which is mapped to Country in ontology.

This mapping would be considered compatible because EU-Country is a specialisation of Country. Similarly, there are cases for generalisation.

### Example 4

### Disjoint Concepts are Incompatible

To modify the above example further, there could be concepts such as Eastern-Country, Western-Country, etc defined in the ontology, and EU-Country is a sub-class of Western-Country. Furthermore, the ontology could say Eastern-Country and West-Country are disjoint. That means if a country is an eastern-Country, it could not be a West-Country, and vice versa.

Now let's say we have a table called Affordable-Product and a table called Developing-Nation

The table Developing-Nation with attributes defined as
id: integer primary key
name: string

A table Affordable-Product with attributes
origin: Integer foreign key reference Developing-Nation (id)
name: string

We add the following mappings:

Eastern-Country of the ontology maps to the table Developing-Nation

Now if we want to map EU-Product of the ontology to Affordable-Product table, and map make-in to origin, this mapping would be invalid because the type of make-in is EU-Country and the type of origin is Developing-Nation. Because Developing-Nation table is mapped to Eastern-Country, we have disjoint types: EU-Country and Eastern-Country. Please note EU-Country is a sub class of Western-Country.

### Example 5

### Other Examples

Names could be defined in an ontology as follows:

Name
first-name: String
last-name: String

A database table may have a column called name which is a string type. But the string could have a syntax as first-name, last-name. That means any name string must be written as Joe, Bloggs; Tom, Bloggs; etc

If an attribute of Concept is type of Name is mapped to a table column called name, we must do type conversion and syntax conversion: structure to string and adding or removing comma, depending which directions the transformation is performed.

We have seen foreign key and disjoint consistency checking. An example of 1 to 1 consistency checking could be as follows:

Let's say every project has a manager and a manager could manage only one project. This constraint could be defined in a database as well as an ontology. When mappings are created between the ontology and the database, this constraint is checked by the system.

### Example 6

### Consistency

Consider:

Ontology—Price:amount, currency-type

Database—Book: title, cost, currency

Cost mapped to price with a fixed currency-type=US$
Currency mapped to Currency-Type

Then this is inconsistent because US$ is a fixed currency-type and apparently the currency in the database schema refers to a type of currencies. This is done by executing pre-defined consistency rules. Other consistency rules include: foreign key relationships, 1 to 1 relationships, and disjoint concepts. There are a set of plug-in modules currently written in the present embodiment to perform the above mentioned checks. Note that the mapping editor application reads a file in which checking modules are stored each time it needs to perform such checks. In this way, further checking modules can be added at any time to enhance the functionality of the mapping editor.

1. A method of generating a computer readable data file representative of a mapping or partial mapping between a first and a second representation of a set of concepts and associated attributes, the method comprising the steps of:
controlling a video display unit to display said first and second representations, or portions thereof, to a user;
detecting input by the user of a signal specifying a value of one or more concepts or attributes or specifying a link between two or more concepts or attributes from the first and second representations;
calculating the logical implications of such specified values or links;
controlling the visual display unit to display to the user indications of the calculated logical implications of the specified values and links; and
generating a computer readable data file representative of said mapping or partial mapping which includes both values and/or links specified by said user and the logical implications thereof calculated in the calculating step.

2. A method according to claim 1 further including storing a plurality of program modules each of which performs one or more logical implication calculations, and wherein the step of calculating logical implications includes accessing and executing the stored program modules, whereby the method may be easily improved by adding new program modules.

3. A method according to claim 1 wherein one of the logical implications calculated is whether the types of two attributes mapped together are the same, or are convertible from one to another by an already stored conversion function, or whether the user needs to supply a new suitable conversion function.

4. A method according to claim 1 wherein one of the logical implications calculated is whether a new linkage of two attributes or concepts or a new assignment of a value to a concept or attribute is logically inconsistent with any previously made linkages or assignments.

5. A method according to claim 1 including the step of determining which concepts and attributes are not linked to other concepts or attributes and are not assigned to a fixed value and marking these as requiring user attention.

6. A method according to claim 5 further including marking the mapping as complete once all concepts or attributes are detected as being either linked to other concepts or attributes or as being assigned to a fixed value or as having been assigned to an unmapped status by the user.

7. A method according to claim 1 further including:
comparing underlying attributes or sub-attributes of the linked concepts or attributes to one another in conjunction with associated mapping rules, the comparison including comparing the types of the underlying attributes or sub-attributes;
automatically forming a link to the underlying attributes or sub-attributes determined to match according to the comparison step; and
controlling the visual display unit to display to the user indications of the automatically formed links.

8. A method according to claim 7 wherein the comparison step attempts to find a match between the names of the underlying attributes or sub-attributes in conjunction mapping rules stored in association with each respective parent concept or attribute.

9. A method according to claim 8 wherein if a match between the names of a pair of underlying attributes or sub-attributes is found, the comparison step further checks the types of the matched underlying attributes or sub-attributes and if the types are the same or if there is an appropriately associated conversion function available then it is determined that there is also a type match, but otherwise it is determined that there is a type-mismatch.

10. A method according to claim 9 wherein if a match between the names of a pair of underlying attributes or sub-attributes is found, the comparison further checks for consistency with previous mappings between concepts, attributes and sub-attributes and designates the linkage as either consistent or inconsistent in dependence on the result.

11. A method according to claim 10 wherein if an automatically formed link is found to be consistent but to have a type mismatch, the linkage is automatically made but the display is caused to generate an indication that there is a type mismatch.

12. A method according to claim 10 wherein if a link is found to be inconsistent it is not made.

13. Apparatus for generating a computer readable data file representative of a mapping or partial mapping between a first and a second representation of a set of concepts and associated attributes, the apparatus comprising:
a display driver for controlling a video display unit to display said first and second representations, or portions thereof, to a user;
an input interface for detecting input by the user of a signal specifying a value to be assigned to one or more concepts or attributes or specifying a link between two or more concepts or attributes from the first and second representations;
a processor for calculating the logical implications of such specified values or links and for generating a computer readable data file representative of said mapping or partial mapping which includes both values and/or links specified by said user and the logical implications thereof calculated in the calculating step; wherein
said display driver is additionally operable to control the visual display unit to display to the user indications of the calculated logical implications of the specified values and links.

14. Apparatus according to claim 13 wherein the processor is further operable to compare underlying attributes or sub-attributes of the linked concepts or attributes to one another in conjunction with associated mapping rules, the comparison including comparing the types of the underlying attributes or sub-attributes and to form automatically a link to the underlying attributes or sub-attributes determined to match according to the comparison; and wherein the display driver is additionally operable to control the visual display unit to display to the user indications of the automatically formed links.

15. Apparatus according to claim 13 further comprising an electronic data store for storing the mapping or partial mapping generated by said processor.

16. A computer program or programs arranged such that while it or they are executed on a computer it or they cause the computer to carry out the method of claim 1.

17. A computer readable carrier medium carrying the computer program or programs of claim 16.
